(19) United States
(12) Patent Application Publication
(10) Pub. No.: US 2008/0131192 A1
(43) Pub. Date: Jun. 5, 2008

(54) Sponge that contains solid or viscous soap and method and system for manufacturing same

(76) Inventor: Israel Tsabari, Tel Aviv (IL)

Correspondence Address: ISRAEL TSABARI, P.O. Box 29746, TEL AVIV, 61297, omitted

(21) Appl. No.: 11/606,987

(22) Filed: Dec. 1, 2006

(51) Int. Cl. B43K 8/00

(52) U.S. Cl. 401/196

(57) ABSTRACT

The product, subject of the present invention, is a sponge that contains solid or viscous soap. The soap in the sponge does not constitute a unit that is separate or independent from the sponge. The soap in the sponge is dispersed throughout the sponge and there is no clear boundary between the sponge and the soap. The method, subject of the present invention, enables to insert liquid soap into the sponge and turn it into solid or viscous soap. The present method includes the following actions: A perforated tubule is inserted into the sponge. A defined dose of liquid soap is inserted into the sponge through the tubule, causing the liquid soap to disperse throughout most parts of the sponge. The liquids in the sponge are dried, to obtain a sponge that contains solid or viscous soap. Drying of the liquids can be done by leaving the sponge in the work room, or by use of a microwave or conventional oven. The system, subject of the present invention, aims to implement the method and comprises: A tank containing the liquid soap; a pump for pumping the liquid soap from the tank into the tubule; a pedal, which when pressed activates the pump and inserts a defined dose of liquid soap into the sponge.

### TECHNICAL FIELD

The product, the method and the system, that are subject of the present invention, are a sponge that contains a solid or viscous soap, a method of inserting the soap into the sponge and drying the liquids, and a system to implement the method.

### BACKGROUND ART

The general public uses, nowadays, a wide variety of sponges for bathing; washing the body; washing facilities, tools and accessories; washing dishes; sponges for spreading lotions, oils and similar preparations; and other such applications in the area of bathing, sanitation and cosmetics. It is customary that in order to use the sponge, the user sprays or splashes liquid soap or other relevant material (hereinafter referred to as “liquid soap” and/or “soap”) from a container onto the sponge. Another way to use sponges is by rubbing a solid soap on the sponge to achieve the same result.

The present invention substantially improves the currently use of soap and sponges. The product, subject of the present invention, is, as aforementioned, a sponge that contains solid or viscous soap. The product, subject of the present invention, is a sponge that contains solid or viscous soap, which enables multiple usage for extended periods of time. Whenever the user wets or dampens the sponge, a small portion of the soap within the sponge is dissolved and enables the cleaning action. The product, subject of the present invention, provides the user with several advantages, including: (a) The product, subject of the present invention, renders it unnecessary to have a liquid soap container, since the soap is already in the sponge. (b) In addition, the user can have many sponges, each of which contains a different kind of soap (different in terms of scent, color, oiliness, etc.), whereas nowadays it is expensive and not worthwhile to have such a wide variety of liquid soap containers at the same time. (c) In addition, in many outdoor locations, use of the product, subject of the present invention, renders it unnecessary to carry along and have a liquid soap container. For instance, at picnics, on excursions, in hotels, etc. Users can also keep the product, subject of the present invention, in their car or at their place of work without having to have a liquid soap container as well. The method and the system, that are subject of the present invention, enable to insert different existing kinds of liquid soap into a wide variety of existing sponges, and to turn the soap to a solid or viscous soap.

### THE INVENTION

The product, which is the subject of the present invention, is a sponge that contains solid or highly viscous soap. The soap in the sponge does not constitute a unit that is separate or independent from the sponge and is not contained within a separate cavity within the sponge, but rather the soap in the sponge, which is the subject of this invention, is dispersed throughout the sponge, and mainly in the middle part of the sponge, so that when the soap is solid it contains parts of the sponge itself, and there is no clear boundary between the sponge and the solid of viscous soap. This point will be better clarified in the description of the method, subject of the present invention.

The method, subject of the present invention, enables to insert existing kinds of liquid soaps into a wide variety of existing sponges, and to turn the soap to a solid or highly viscous soap. The method of inserting the liquid soap into the sponge and turning it into a solid or highly viscous soap consists of the following actions: (a) Inserting a tubule with one or more perforations into the center of the sponge. (b) Inserting liquid soap through the tubule into the sponge, causing the liquid soap to disperse throughout most parts of the sponge. (c) Drying out the liquids (the aqueous part of the soap) in the sponge, to obtain a sponge that contains a solid or highly soap.

The tubule may have only one hole, but the method, subject of the present invention, will be more efficient if the tubule has several holes around its entire perimeter and along the entire the part of the tubule that is inserted into the sponge. Thus, the soap will be dispersed farther and more uniformly within the sponge.

The liquid soap inserted into the sponge can be a ready-made off-the-shelf product made by manufacturers. However, the method, subject of the present invention, will be more efficient if the soap is diluted with water or essential oils or any other desired liquid, preferably at a ratio of up to 10% of the liquid soap volume. The objective of this is to achieve more effective flow, insertion, and dispersion of the liquid soap throughout all parts of the sponge.

Drying of the sponge containing the liquid soap can be executed be by leaving it in the work room. However, the method, subject of the present invention, will be more efficient if drying is executed by placing the sponge in a warm place in order to evaporate and dry out the liquids from the sponge, for example in microwave or conventional oven.

Insertion of the liquid soap into the sponge should be in predetermined and predefined doses. The method, subject of the present invention, will be more efficient if the insertion of the liquid soap into the sponge through the tubule is executed using a pump that will insert a defined dose of liquid soap through the tubule whenever a certain button is pushed or whenever the pump is given a certain signal to insert the said defined dose.

The system, subject of the present invention, enables to implement the method for the insertion of liquid soap into the sponge and for turning the soap into a solid or highly viscous soap. The system, subject of the present invention, is composed of the following components: (a) A tank containing the liquid soap. (b) A pump that connects to the tank and enables pumping of the liquid soap from the tank through a pipe that is connected to the tubule, which will described hereinafter. (c) A tubule with one or more holes, which is intended for insertion into the sponge. The system may possibly, but not necessary, include the following components as well: (d) A pedal that when pressed activates the pump for a certain predefined period of time in order to insert a defined dose of liquid soap into the sponge. (e) A worktable that will serve as a production assembly line, onto which the tubule is affixed. The sponges are moved along the table. Each sponge, in turn, is attached to the tubule until the tubule is inserted into the sponge. The pedal is pressed and the pump inserts the desired dose of liquid soap into the sponge. It goes without saying that there can be several tubules that can act simultaneously, and it is also possible that the tubule will be the element that moves and is inserted into the sponge and not vice versa.

What is claimed is:

1. A sponge that contains a solid or viscous soap whereby the soap does not constitute an independent and separate unit within the sponge and is not contained in a separate cavity, but rather is dispersed in the middle of the sponge and is intermixed with the sponge itself.

2. A method of inserting liquid soap into a sponge and turning the soap to a solid or viscous soap, which includes the following actions: (a) Inserting a tubule with one or more holes into the middle of the sponge. (b) Inserting liquid soap through the tubule into the sponge. (c) Drying out the liquids that are in the sponge to obtain a sponge that contains solid or viscous soap.

3. The method described in claim 2 wherein the liquid soap is diluted with water or essential oils or any desired liquid prior to its insertion into the sponge.

4. The method described in claim 3 wherein the dilution ratio of water or oils to liquid soap is 1/10.

5. The method described in claim 2 wherein drying the liquids out of the sponge is executed by placing the sponge in a warm place, for example in microwave or conventional oven.

6. The method described in claim 2 wherein insertion of liquid soap into the sponge is executed in predefined and predetermined doses.

7. A system to implement the method described in claim 2 for the manufacture of the product described in claim 1, which includes the following components: (a) A tank containing the liquid soap. (b) A pump that pumps the liquid soap from the tank into the tubule. (c) A tubule with one or more holes that is inserted into the sponge.

8. The system described in claim 7 wherein the tubule has several holes around its perimeter and along of the part of the tubule that is inserted into the sponge.

9. The system described in claim 7 including a pedal that activates the pump for a certain and predetermined period of time, that enables to insert a defined dose of liquid soap into the sponge.
